(19) United States
(12) Patent Application Publication
(10) Pub. No.: US 2024/0243365 A1
(43) Pub. Date: Jul. 18, 2024

(54) Solid-State Traction Battery Having Battery Cells with Overhanging Electrode

(71) Applicant: Ford Global Technologies, LLC, Dearborn, MI (US)

(72) Inventors: Xin Liu, Novi, MI (US); Andrew Robert Drews, Ann Arbor, MI (US); Christian Edward Shaffer, Canton, MI (US); Hyukkeun Oh, Ann Arbor, MI (US)

(73) Assignee: Ford Global Technologies, LLC, Dearborn, MI (US)

(21) Appl. No.: 18/097,671

(22) Filed: Jan. 17, 2023

(51) Int. Cl. H01M 10/0585; B60L 50/64; H01M 10/0525

(52) U.S. Cl. CPC H01M 10/0585; B60L 50/64; H01M 10/0525; H01M 2220/20

(57) ABSTRACT

A battery cell of a solid-state battery, such as a solid-state traction battery of an electrified vehicle, includes first and second electrodes and a solid electrolyte sandwiched between the electrodes in a stack. The first electrode overhangs the second electrode in the stack. The solid electrolyte may have a surface area that is the same as the surface area of the first electrode with the solid electrolyte together with the first electrode overhang the second electrode in the stack. The battery cell may further include a current collector having a main portion and a tab region extending therefrom. The current collector is arranged in the stack with the second electrode sandwiched between the main portion of the current collector and the solid electrolyte and with the first electrode overhanging the tab region of the current collector. An electrical insulation layer is applied to the tab region of the current collector.

### TECHNICAL FIELD

The present disclosure relates to a solid-state traction battery for an electrified vehicle.

### BACKGROUND

An electrified vehicle includes a traction battery for providing power to a motor of the vehicle to propel the vehicle. The traction battery is comprised of battery cells.

### SUMMARY

A solid-state battery cell (SSB cell) having a first electrode, a second electrode, and a solid electrolyte is provided. The first electrode, the second electrode, and the solid electrolyte are arranged in a stack with the solid electrolyte being sandwiched between the first electrode and the second electrode. The first electrode has a surface area larger than a surface area of the second electrode with the first electrode overhanging the second electrode in the stack.

The solid electrolyte may have a surface area that is the same as the surface area of the first electrode with the solid electrolyte together with the first electrode overhang the second electrode in the stack.

The solid electrolyte may be assembled to the first electrode prior to the first electrode and the solid electrolyte being arranged in the stack.

The SSB cell may further include a current collector having a main portion and a tab region extending therefrom. The current collector is arranged in the stack with the second electrode being sandwiched between the main portion of the current collector and the solid electrolyte and with the first electrode overhanging the tab region of the current collector. An electrical insulation layer applied to the tab region of the current collector.

The SSB cell may further include a second current collector. The second current collector is arranged in the stack with the first electrode being sandwiched between the second current collector and the solid electrolyte.

The first electrode may be an anode, and the second electrode may be a cathode. Alternatively, the first electrode may be a cathode, and the second electrode may be an anode.

The second electrode may have a first part that is overhung by the first electrode and a second part that overhangs the first electrode. In this case, the SSB cell may further include a current collector having a main portion and a tab region extending therefrom. The current collector is arranged in the stack with the first part of the second electrode being sandwiched between the main portion of the current collector and the solid electrolyte and with the second part of the second electrode being sandwiched on one side by the tab region of the current collector. The second part of the second electrode is sandwiched on an opposite side by an electrical insulation layer.

The electrical insulation layer may be a solid electrolyte electrical insulation layer.

A SSB having a plurality of the battery cells arranged in the stack is also provided.

An electrified vehicle having a traction battery in the form of the SSB is also provided.

### BRIEF DESCRIPTION OF THE DRAWINGS

FIG. 1 illustrates a block diagram of a battery electric vehicle (BEV) having a solid-state traction battery (SSB) such as a lithium-ion SSB;

FIG. 2 illustrates a legend for battery cell components shown in the sketches of the drawings;

FIG. 3A illustrates a plan sketch of a battery cell of a conventional lithium-ion traction battery;

FIG. 3B illustrates a plan sketch of a battery cell of the SSB, the SSB cell including a negative electrode (i.e., an anode), a positive electrode (i.e., cathode), and a solid electrolyte between the anode and the cathode, the SSB cell having an overhang design in which one of the electrodes (e.g., the anode) to which the solid electrolyte is pre-assembled overhangs the other one of the electrodes (e.g., the cathode);

FIG. 3C illustrates a plan sketch of the SSB cell further having an electrical insulation layer at the tab region of a current collector (e.g., cathode current collector) of the overhung electrode (e.g., the cathode);

FIG. 4A illustrates a cross-sectional sketch of a stack of stacked SSB cells without the electrical insulation layer at the tab region of the current collector (e.g., the cathode current collector) of the overhung electrodes (e.g., the cathodes) as shown in FIG. 3B;

FIG. 4B illustrates a cross-sectional sketch of the stack of stacked SSB cells with the electrical insulation layer at the tab region of the current collector of the overhung electrodes as shown in FIG. 3C;

FIG. 5A illustrates a plan sketch of the SSB cell in which the SSB cell has an overhanging electrode coating (e.g., overhanging cathode coating) on the tab region of the current collector (e.g., cathode current collector) of the overhung electrode (e.g., the cathode);

FIG. 5B illustrates a plan sketch of the SSB cell shown in FIG. 5A with an electrical insulation layer applied on the overhanging electrode coating on the tab region of the current collector of the overhung electrode;

FIG. 6 illustrates a cross-sectional sketch of a stack of stacked SSB cells with the electrical insulation layer applied on the overhanging electrode coating on the tab region of the current collector of the overhung electrodes as shown in FIG. 5B;

FIG. 7A illustrates a plan sketch of the SSB cell in which the SSB cell has a solid electrolyte electrical insulation layer applied on the entire electrode coating (e.g., the entire cathode coating) of the overhung electrode (e.g., the cathode);

FIG. 7B illustrates a cross-sectional sketch of a stack of stacked SSB cells with the solid electrolyte electrical insulation layer applied on the entire electrode coating of the overhung electrodes as shown in FIG. 7A;

FIG. 8A illustrates a plan sketch of the SSB cell in which the SSB cell has a solid electrolyte electrical insulation layer applied on the overhanging electrode coating (e.g., overhanging cathode coating) on the tab region of the current collector (e.g., cathode current collector) of the overhung electrode (e.g., the cathode);

FIG. 8B illustrates a cross-sectional sketch of a stack of stacked SSB cells with the solid electrolyte electrical insulation layer applied on the overhanging electrode coating on the tab region of the current collector of the overhung electrode as shown in FIG. 8A; and

FIGS. 9A, 9B, 9C, and 9D illustrate respective sketches pertaining to general manufacturing processes for assembling an electrical insulation layer to the tab region of a current collector (e.g., cathode current collector) of an electrode (e.g., cathode).

### DETAILED DESCRIPTION

Detailed embodiments of the present disclosure are disclosed herein; however, it is to be understood that the disclosed embodiments are merely exemplary of the present disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

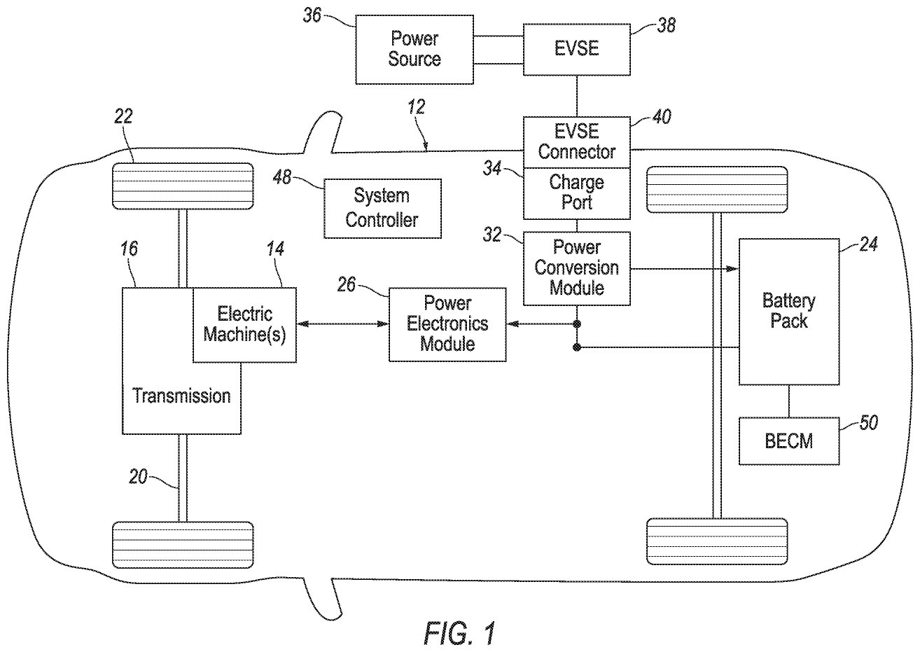

Referring now to FIG. 1, a block diagram of an electrified vehicle 12 in the form of a battery electric vehicle (BEV) is shown. BEV 12 includes a powertrain having one or more traction motors (“electric machine(s)”) 14, a traction battery (“battery” or “battery pack”) 24, and a power electronics module 26 (e.g., an inverter). In the BEV configuration, traction battery 24 provides all of the propulsion power and the vehicle does not have an engine. In other embodiments, the vehicle may be a plug-in hybrid electric vehicle (PHEV) further having an engine.

Traction motor 14 is part of the powertrain of BEV 12 for powering movement of the BEV. In this regard, traction motor 14 is mechanically connected to a transmission 16 of BEV 12. Transmission 16 is mechanically connected to a drive shaft 20 that is mechanically connected to wheels 22 of BEV 12. Traction motor 14 can provide propulsion capability to BEV 12 and is capable of operating as a generator. Traction motor 14 acting as a generator can recover energy that may normally be lost as heat in a friction braking system of BEV 12.

Traction battery 24 stores electrical energy that can be used by traction motor 14 for propelling BEV 12. Traction battery 24 typically provides a high-voltage (HV) direct current (DC) output. Traction battery 24 is electrically connected to power electronics module 26. Traction motor 14 is also electrically connected to power electronics module 26. Power electronics module 26, such as an inverter, provides the ability to bi-directionally transfer energy between traction battery 24 and traction motor 14. For example, traction battery 24 may provide a DC voltage while traction motor 14 may require a three-phase alternating current (AC) current to function. Inverter 26 may convert the DC voltage to a three-phase AC current to operate traction motor 14. In a regenerative mode, inverter 26 may convert three-phase AC current from traction motor 14 acting as a generator to DC voltage compatible with traction battery 24.

In addition to providing electrical energy for propulsion of BEV 12, traction battery 24 may provide electrical energy for use by other electrical systems of the BEV such as HV loads like fan, electric heater, and air-conditioner systems and low-voltage (LV) loads such as an auxiliary battery.

Traction battery 24 is rechargeable by an external power source 36 (e.g., the grid). External power source 36 may be electrically connected to electric vehicle supply equipment (EVSE) 38. EVSE 38 provides circuitry and controls to control and manage the transfer of electrical energy between external power source 36 and BEV 12. External power source 36 may provide DC or AC electric power to EVSE 38. EVSE 38 may have a charge connector 40 for plugging into a charge port 34 of BEV 12.

A power conversion module 32 of BEV 12, such as an on-board charger having a DC/DC converter, may condition power supplied from EVSE 38 to provide the proper voltage and current levels to traction battery 24. Power conversion module 32 may interface with EVSE 38 to coordinate the delivery of power to traction battery 24.

The various components described above may have one or more associated controllers to control and monitor the operation of the components. The controllers can be microprocessor-based devices. The controllers may communicate via a serial bus (e.g., Controller Area Network (CAN)) or via discrete conductors.

For example, a system controller 48 (“vehicle controller”) is present to coordinate the operation of the various components. Controller 48 includes electronics, software, or both, to perform the necessary control functions for operating BEV 12. In embodiments, controller 48 is a combination vehicle system controller and powertrain control module (VSC/PCM). Although controller 48 is shown as a single device, controller 48 may include multiple controllers in the form of multiple hardware devices, or multiple software controllers with one or more hardware devices. In this regard, a reference to a “controller” herein may refer to one or more controllers.

Controller 48 implements a battery energy control module (BECM) 50. BECM 50 is in communication with traction battery 24. BECM 50 is a traction battery controller operable for managing the charging and discharging of traction battery 24 and for monitoring operating parameters of traction battery 24. BECM 50 may implement algorithms to measure and/or estimate the operating parameters of traction battery 24. BECM 50 controls the operation and performance of traction battery 24 based on the operating parameters of the traction battery.

The operating parameters of traction battery 24 include the temperature, the charge capacity, and the state of charge (SOC) of the traction battery. For reference, the charge capacity of traction battery 24 is indicative of the amount of electrical energy that the traction battery may store. The SOC of traction battery 24 is indicative of a present amount of electrical energy stored in the traction battery. The SOC of traction battery 24 may be represented as a percentage of a maximum amount of electrical energy that may be stored in the traction battery. Traction battery 24 may also have corresponding charge and discharge power limits that define the amount of electrical power that may be supplied to or by the traction battery at a given time.

Traction battery 24 may have one or more temperature sensors such as thermistors in communication with BECM 50 to provide data indicative of the temperature of battery cells of the traction battery for the BECM to monitor the temperature of the traction battery. BEV 12 may further include a temperature sensor to provide data indicative of ambient temperature for BECM 50 to monitor the ambient temperature.

Traction battery 24 is a solid-state traction battery (SSB) and is comprised of a plurality of battery cells. Each battery cell is comprised of a negative electrode (i.e., an anode), a positive electrode (i.e., cathode), and a solid electrolyte between the anode and the cathode. An anode current collector (e.g., copper foil) is arranged on the side of the anode opposite from the solid electrolyte and a cathode current collector (e.g., aluminum foil) is arranged on the side of the cathode opposite from the solid electrolyte. The current collectors of the battery cell are respectively connected to the current collectors of other battery cells of the SSB for all of these battery cells to be connected together such as in series or in parallel.

SSB 24 may be a lithium-ion SSB. As such, the cathode may be comprised of a lithium metal oxide and the anode may be comprised of a lithium metal.

A SSB such as a lithium-ion SSB may provide a more beneficial electrified vehicle battery solution with a higher energy density compared with a conventional lithium-ion traction battery (“conventional LiB”). It would be beneficial to develop SSB technology that can be manufactured using existing conventional LiB equipment and processes. Unlike a conventional LiB, the solid electrolyte in a SSB physically separates the cathode and the anode thereby eliminating the need for a separator (e.g., a porous polymer separator). Due to the mechanical properties of the solid electrolyte, especially those solid electrolytes based on ceramic or sulfide, the solid electrolyte faces challenges to be assembled into battery cells through similar techniques as conventional LiBs, such as Z-folding a free-standing separator.

As disclosed herein, SSB 24 has a battery cell design in which the battery cells of the SSB can be manufactured in a similar process as the battery cells of a conventional LiB while reducing the chance of an internal short circuit.

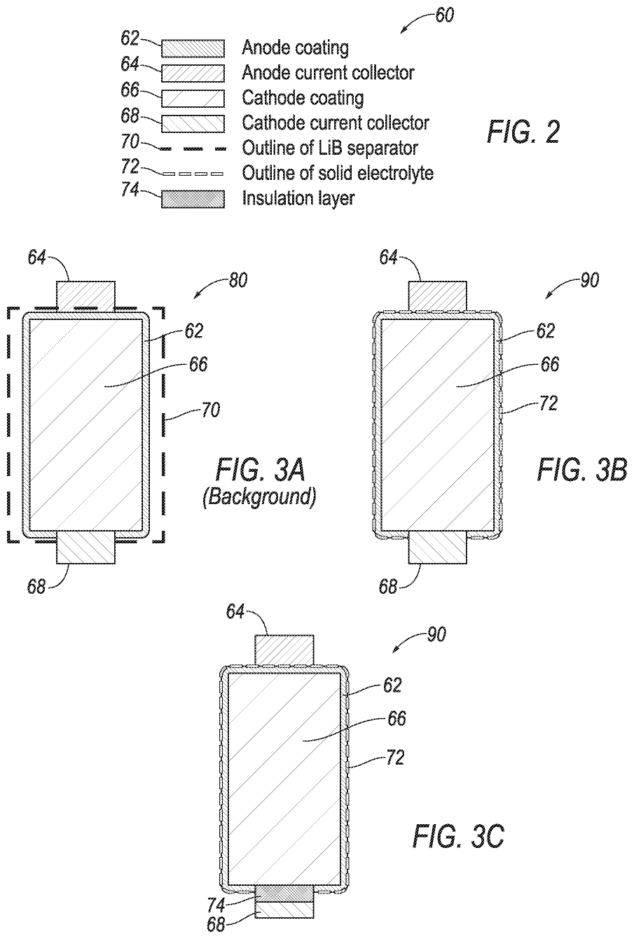

Referring initially to FIG. 2, a legend 60 of battery cell components shown in the sketches of the drawings is shown. The battery cell components set forth in legend 60 include an anode coating 62 (i.e., negative electrode material) or anode (i.e., negative electrode), an anode current collector 64 (i.e., negative electrode current collector), a cathode coating 66 (i.e., positive electrode material) or cathode (i.e., positive electrode), a cathode current collector 68 (i.e., positive electrode current collector), a conventional LiB separator 70, a solid electrolyte 72, and an electrical insulation layer 74.

Referring now to FIG. 3A, a plan sketch of a battery cell 80 of a conventional LiB is shown. Conventional LiB cell 80 includes an anode 62, a conventional LiB separator 70, and a cathode 64 stacked on one another with the conventional LiB separator being sandwiched between the anode and the cathode. As shown in the plan sketch of FIG. 3A, in the conventional LiB cell design, anode 62 has an overhanging design. Anode 62 has an overhanging design to prevent lithium plating. The “overhanging” of anode 62 is a result of the anode having a larger surface area than cathode 66. As such, when anode 62 and cathode 66 are centrally stacked opposed one another, as shown in the plan sketch of FIG. 3A, the sides of the anode (in this example, four sides) extend beyond the corresponding sides of the cathode, as also shown in the plan sketch of FIG. 3A. In this way, anode 62 “overhangs” cathode 66 (and cathode 66 is “overhung” by anode 62). Further, conventional LiB separator 70, which is sandwiched between opposed surfaces of anode 62 and cathode 66, overhangs both of the anode and the cathode. Conventional LiB separator 70 overhangs anode 62 and cathode 66 to prevent any direct physical contact between the sides of the anode with the sides of the cathode.

Conventional LiB cell 80 further includes an anode current collector 64 and a cathode current collector 68. Anode current collector 64 is arranged on the surface of anode 62 opposite from the surface of the anode facing conventional LiB separator 70. Likewise, cathode current collector 68 is arranged on the surface of cathode 66 opposite from the surface of the cathode facing conventional LiB separator 70.

A portion of anode current collector 64 in the form of an external tab extends out from one end of the corpus of conventional LiB cell 80. Likewise, a portion of cathode current collector 68 in the form of an external tab extends out from the corpus of conventional LiB cell 80. In this example, the anode current collector external tab and the cathode collector external tab extend out from opposite ends of the corpus of conventional LiB cell 80. The external tabs are accessible to be respectively connected to the external tabs of other battery cells for the battery cells to be connected as a group in series or in parallel with one another.

Referring now to FIG. 3B, with continual reference to FIG. 3A, a plan sketch of a battery cell 90 of SSB 24 is shown. SSB cell 90 includes an anode 62, a solid electrolyte 72, and a cathode 66 stacked on one another with the solid electrolyte separating the anode and the cathode. In SSB cell 90, solid electrolyte 72, instead of conventional LiB separator 70 as with conventional battery cell 80, is sandwiched between opposed surfaces of anode 62 and cathode 66. Solid electrolyte 72 is pre-assembled to one or both of the electrodes (i.e., one or both of anode 62 and cathode 66) before the electrodes are stacked on one another.

In SSB cell 90, one of the electrodes has an overhanging design to prevent internal short circuiting around the electrodes. Such internal short circuiting could otherwise be potentially caused by misalignment of electrodes, burrs at electrode edge after notching, defects of solid electrolyte 72 near edges, etc.

In the example of SSB cell 90 shown in FIG. 3B, like conventional LiB cell 80, anode 62 has an overhanging design whereby the anode has a larger surface area than the surface area of cathode 66. As such, as shown in the plan sketch of FIG. 3B, the sides of anode 62 extend beyond the corresponding sides of cathode 66. (In other examples, cathode 66 has an overhanging design whereby the cathode has a larger surface area than the surface area of anode 62.)

Further in SSB cell, a layer of solid electrolyte 72 is pre-assembled (e.g., pre-laminated) to the coating of the electrode having the overhanging design. Solid electrolyte 72 thereby has the same surface area as the surface area of the overhanging electrode.

As such, in the example of SSB cell 90 shown in FIG. 3B, a layer of solid electrolyte 72 is pre-laminated to the coating of anode 62 and the solid electrolyte has the same relatively larger surface area as anode 62. Consequently, cathode 66 is overhung by anode 62 with the layer of solid electrolyte 72. Notably, the overhang size of solid electrolyte 72 is smaller than the overhang size of conventional LiB separator 70, ranging from 0.2 mm to 2.0 mm depending on process and equipment tolerance. (In other examples in which cathode 66 has the overhanging design, solid electrolyte 72 is pre-laminated to the cathode and anode 62 is overhung by the cathode with the layer of solid electrolyte.)

As set forth, in the example of SSB cell 90 shown in FIG. 3B, the SSB cell includes a negative electrode (i.e., anode 62), a positive electrode (i.e., cathode 66), and a solid electrolyte 72 between the anode and the cathode, the anode having an overhanging design, the solid electrolyte being pre-assembled to the anode and having the same overhanging design, and the cathode being overhung by the anode and by the solid electrolyte.

Referring now to FIG. 3C, with continual reference to FIG. 3B, a plan sketch of SSB cell 90 further having an electrical insulation layer 74 at the tab region of the current collector of the overhung (smaller) electrode is shown. As indicated, in the example of SSB cell 90 shown in FIG. 3C, cathode 66 is the overhung electrode. As such, in the example of SSB cell 90 shown in FIG. 3C, electrical insulation layer 74 is applied at the tab region of cathode current collector 68. Electrical insulation layer 74 is applied at the tab region of the overhung electrode to prevent the chance of overhanging electrodes contacting opposing electrode tabs.

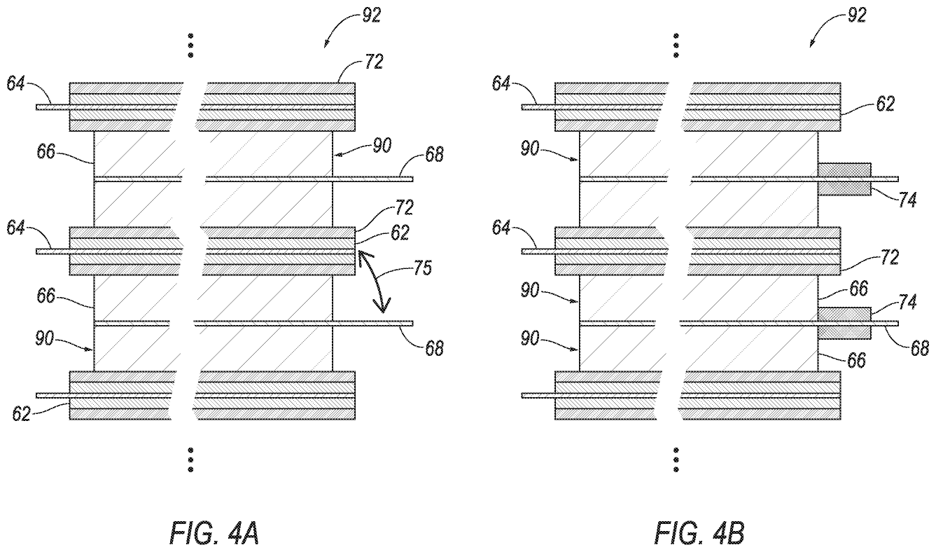

Referring now to FIG. 4A, with continual reference to FIGS. 3B and 3C, a cross-sectional sketch of a stack 92 of stacked SSB cells 90 without electrical insulation layer 74 at the tab region of the overhung electrodes is shown. As electrical insulation layer 74 is absent, each SSB cell 90 in stack 92 corresponds to the SSB cell design shown in FIG. 3B.

Electrical insulation layer 74 is absent in FIG. 4A to provide an example illustrating an area 75 of each SSB cell 90 where short-circuiting could occur. In this example, area 75 is where an overhanging portion of anode coating 62 could physically touch cathode current collector 68 and thereby produce a short circuit. For instance, in area 75, burrs from anode electrodes are susceptible to short circuit by physically touching the cathode tab. The potential for such short circuiting can be reduced by applying electrical insulation layer 74 at the tab region of the cathode tab. In this regard, FIG. 4B illustrates a cross-sectional sketch of a stack 92 of stacked SSB cells 90 with electrical insulation layer 74 at the tab region of the current collector of the overhung electrodes.

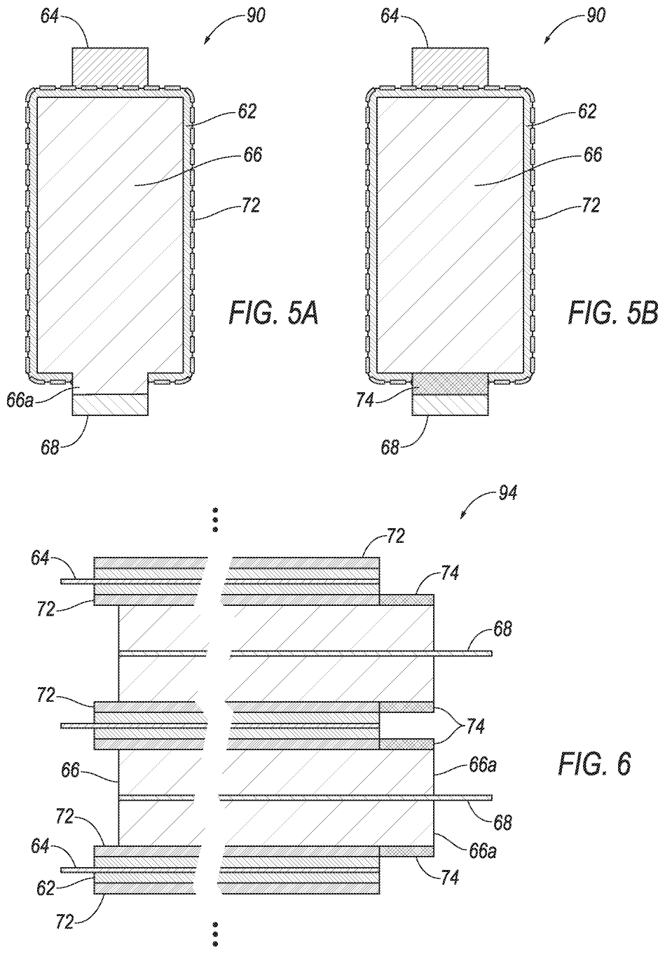

Referring now to FIGS. 5A and 5B, with continual reference to FIGS. 3B and 3C, plan sketches of SSB cell 90 in which the SSB cell has an overhanging electrode coating on the tab region of the current collector of the overhung electrode are shown. As such, the larger electrode overhangs the smaller electrode but the electrode coating line on the tab region of the current collector of the smaller electrode overhangs the opposing larger electrode. Accordingly, in this example in which SSB cell 90 has an overhanging anode 62, the SSB cell has an overhanging cathode coating 66a on the tab region of cathode current collector 68 of the overhung cathode 66.

In FIG. 5A, electrical insulation layer 74 applied on overhanging cathode coating 66a on the tab region of cathode current collector 68 of the overhung cathode 66 is absent. FIG. 5A further shows overhanging cathode coating 66a on the tab region of cathode current collector 68 overhanging anode 62.

In FIG. 5B, electrical insulation layer 74 is applied on overhanging cathode coating 66a on the tab region of cathode current collector 68 of the overhung cathode 66. FIG. 5B further shows electrical insulation layer 74 applied on overhanging cathode coating 66a on the tab region of cathode current collector 68 overhanging anode 62.

As illustrated with reference to FIGS. 5A and 5B, in the scenario where the overhanging electrode coating on the current collector tab of the smaller electrode (cathode 66 in this example) overhangs the opposing electrode (anode 62 in this example), electrical insulation layer 74 can be applied on the overhanging electrode coating. In summary, FIGS. 5A and 5B pertain to an example showing electrical insulation layer 74 applied on overhanging cathode coating on the tab region with anode overhanging design.

Referring now to FIG. 6, with continual reference to FIG. 5B, a cross-sectional sketch of a stack 94 of stacked SSB cells 90 with electrical insulation layer 74 applied on the overhanging electrode coating on the tab region of the current collector of the overhung electrodes is shown. As electrical insulation layer 74 is present, each SSB cell 90 in stack 94 corresponds to the SSB cell design shown in FIG. 5B. Accordingly, electrical insulation layer 74 is applied on overhanging electrode coating 66a on the tab region of cathode current collector 68 of cathode 66.

Electrical insulation layer 74 can be made from electrical non-conductors such as solid electrolyte, polymer, or ceramics. When a solid electrolyte is used as an electrical insulation layer, a solid electrolyte electrical insulation layer can be applied either on the entire surface of an electrode or just on the tab region of a current collector of the electrode.

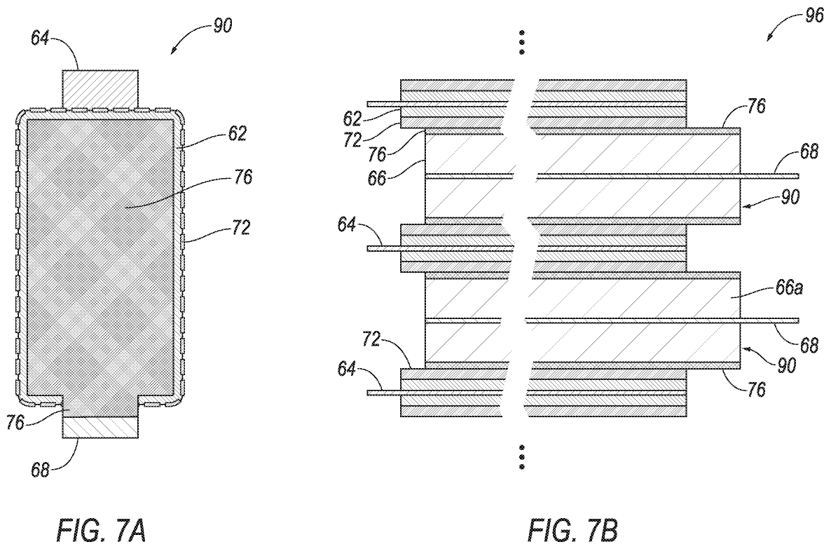

Referring now to FIG. 7A, with continual reference to FIG. 5A, a plan sketch of SSB 90 cell in which the SSB cell has a solid electrolyte electrical insulation layer 76 applied on the entire electrode coating (e.g., the entire cathode coating) of the overhung electrode (e.g., the cathode). As such, solid electrolyte electrical insulation layer 76 is applied on the surface of the electrode coating including the overhanging electrode coating on the tab region of the current collector of the electrode as opposed to only being applied on the overhanging electrode coating. Accordingly, in this example, SSB cell 90 has an overhanging cathode coating 66a on the tab region of cathode current collector 68 of the overhung cathode 66 and solid electrolyte electrical insulation layer 76 is applied on the surface of cathode 66 including overhanging cathode coating 66a.

Consequently, the portion of solid electrolyte electrical insulation layer 76 applied on the surface of cathode 66 other than overhanging cathode coating 66a is sandwiched between this surface of cathode 66 and solid electrolyte 74. This is shown in FIG. 7B which illustrates a cross-sectional sketch of a stack 96 of stacked SSB cells 90 with solid electrolyte electrical insulation layer 76 applied on entire surfaces of cathodes 66 including overhanging cathode coatings 66a. In summary, FIGS. 7A and 7B pertain to solid electrolyte electrical insulation layer 76 being applied on the entire surface of an electrode.

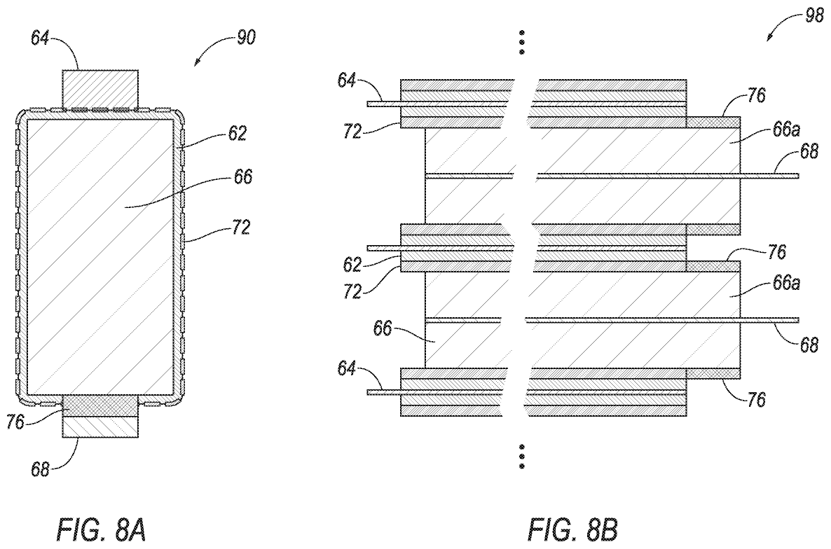

Referring now to FIG. 8A, with continual reference to FIGS. 7A and 7B, a plan sketch of SSB cell 90 in which the SSB cell has a solid electrolyte electrical insulation layer 76 applied on the overhanging electrode coating (e.g., overhanging cathode coating) on the tab region of the current collector (e.g., cathode current collector) of the overhung electrode (e.g., the cathode) is shown. As such, solid electrolyte electrical insulation layer 76 is applied only on the overhanging electrode coating on the tab region of the current collector of the electrode as opposed to being applied on entire surface of the electrode. Accordingly, in this example, SSB cell 90 has an overhanging cathode coating 66a on the tab region of cathode current collector 68 of the overhung cathode 66 and solid electrolyte electrical insulation layer 76 is applied only on the overhanging cathode coating 66a.

Consequently, no portion of the applied solid electrolyte electrical insulation layer 76 is sandwiched between a surface of cathode 66 and solid electrolyte 74. This is shown in FIG. 8B which illustrates a cross-sectional sketch of a stack 98 of stacked SSB cells 90 with solid electrolyte electrical insulation layer 76 applied only on overhanging cathode coatings 66a. In summary, FIGS. 8A and 8B pertain to solid electrolyte electrical insulation layer 76 being applied only on an overhanging coating of an electrode.

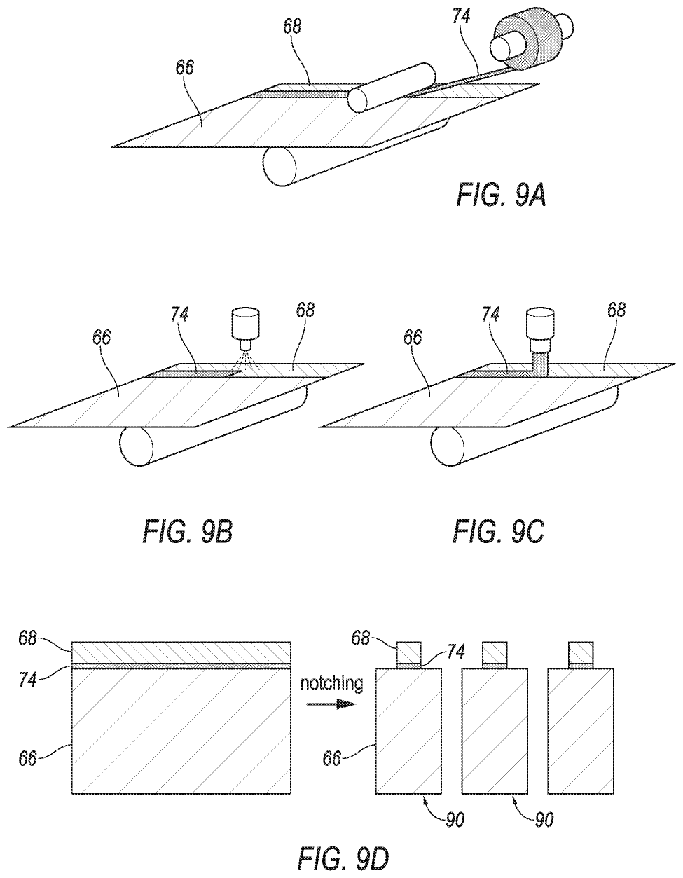

The polymer or ceramic layer can be applied by laminating or taping the electrical insulation material, spray coating, or ink printing as shown in FIGS. 9A, 9B, 9C, and 9D. Alternatively, the electrical insulation layer can be applied on the notched electrodes through process like taping or screen printing after the notching step or before stacking.

As described, conventional LiB cell designs require anode overhang design to prevent lithium plating. Such an overhang design is not required for a solid-state battery (SSB) such as a lithium-ion SSB in which lithium plating is not an issue. Nevertheless, to make use of existing LiB equipment and processes in the manufacturing of a SSB, SSBs in accordance with the present disclosure have the overhang design with further SSB modification to reduce chance of internal short circuit around the electrode edge. Further, as compared to the overhang size of the conventional LiB cell design, the overhang size of the SSB may be smaller which provides higher energy density. In addition, an electrical insulation layer can be applied near the tab region to further reduce the chance of short circuiting. Proposed techniques to apply the electrical insulation layer allow easy integration with current battery cell manufacturing processes.

As set forth, an electrified vehicle solid-state traction battery cell design having an overhang design with an electrically insulated tab region design is provided. Per the overhang design, one of the electrodes of the battery cells to which the solid electrolyte is pre-assembled (i.e., the larger electrode) overhangs the other one of the electrodes (i.e., the smaller electrode). Per the electrical insulated tab region design, an electrical insulation layer is applied to the tab region of the current collector of the smaller electrode.

While exemplary embodiments are described above, it is not intended that these embodiments describe all possible forms of the present disclosure. Rather, the words used in the specification are words of description rather than limitation, and it is understood that various changes may be made without departing from the spirit and scope of the present disclosure. Additionally, the features of various implementing embodiments may be combined to form further embodiments of the present disclosure.

What is claimed is:

1. A solid-state battery cell comprising:
a first electrode;
a second electrode;
a solid electrolyte;
the first electrode, the second electrode, and the solid electrolyte being arranged in a stack with the solid electrolyte being sandwiched between the first electrode and the second electrode; and
the first electrode having a surface area larger than a surface area of the second electrode with the first electrode overhanging the second electrode in the stack.

2. The solid-state battery cell of claim 1 wherein:
the solid electrolyte has a surface area that is the same as the surface area of the first electrode with the solid electrolyte together with the first electrode overhang the second electrode in the stack.

3. The solid-state battery cell of claim 2 wherein:
the solid electrolyte is assembled to the first electrode prior to the first electrode and the solid electrolyte being arranged in the stack.

4. The solid-state battery cell of claim 1 further comprising:
a current collector having a main portion and a tab region extending therefrom, the current collector being arranged in the stack with the second electrode being sandwiched between the main portion of the current collector and the solid electrolyte and with the first electrode overhanging the tab region of the current collector; and
an electrical insulation layer applied to the tab region of the current collector.

5. The solid-state battery cell of claim 4 further comprising:
a second current collector, the second current collector being arranged in the stack with the first electrode being sandwiched between the second current collector and the solid electrolyte.

6. The solid-state battery cell of claim 1 wherein:
the first electrode is an anode, and the second electrode is a cathode.

7. The solid-state battery cell of claim 1 wherein:
the first electrode is a cathode, and the second electrode is an anode.

8. The solid-state battery cell of claim 1 wherein:
the second electrode has a first part and a second part, the first part of the second electrode being overhung by the first electrode and the second part of the second electrode overhanging the first electrode;
the solid-state battery cell further including:
a current collector having a main portion and a tab region extending therefrom, the current collector being arranged in the stack with the first part of the second electrode being sandwiched between the main portion of the current collector and the solid electrolyte and with the second part of the second electrode being sandwiched on one side by the tab region of the current collector; and
an electrical insulation layer, the second part of the second electrode being sandwiched on an opposite side by the electrical insulation layer.

9. The solid-state battery cell of claim 8 wherein:
the electrical insulation layer is a solid electrolyte electrical insulation layer.

10. The solid-state battery cell of claim 1 further comprising:
a solid electrolyte electrical insulation layer, the solid electrolyte electrical insulation layer being arranged in the stack with the solid electrolyte electrical insulation layer being sandwiched between the solid electrolyte and the second electrode.

11. The solid-state battery cell of claim 10 further comprising:
the second electrode has a first part and a second part, the first part of the second electrode being overhung by the first electrode and the second part of the second electrode overhanging the first electrode; and
the solid-state battery cell further including a current collector having a main portion and a tab region extending therefrom, the current collector being arranged in the stack with the first part of the second electrode being sandwiched between the main portion of the current collector and the solid electrolyte electrical insulation layer and with the second part of the second electrode being sandwiched between the tab region of the current collector and the solid electrolyte electrical insulation layer.

12. A solid-state battery comprising:
a first battery cell;
a second battery cell; and
the first battery cell and the second battery cell being arranged in a stack; and
wherein each battery cell includes a first electrode, a second electrode, and a solid electrolyte that are arranged in the stack with the solid electrolyte being sandwiched between the first electrode and the second electrode, and in each battery cell the first electrode has a surface area larger than a surface area of the second electrode with the first electrode overhanging the second electrode in the stack.

13. The solid-state battery of claim 12 wherein:
in each battery cell the solid electrolyte has a surface area that is the same as the surface area of the first electrode with the solid electrolyte together with the first electrode overhang the second electrode in the stack.

14. The solid-state battery of claim 12 wherein:
each battery cell further includes a current collector having a main portion and a tab region extending therefrom, the current collector being arranged in the stack with the second electrode being sandwiched between the main portion of the current collector and the solid electrolyte and with the first electrode overhanging the tab region of the current collector; and
each battery cell further including an electrical insulation layer applied to the tab region of the current collector.

15. The solid-state battery of claim 12 wherein:
in each battery cell the first electrode is an anode, and the second electrode is a cathode.

16. The solid-state battery of claim 12 wherein:
in each battery cell the first electrode is a cathode, and the second electrode is an anode.

17. An electrified vehicle comprising:
a traction battery having a first battery cell and a second battery cell, the first battery cell and the second battery cell being arranged in a stack, wherein each battery cell includes a first electrode, a second electrode, and a solid electrolyte that are arranged in the stack with the solid electrolyte being sandwiched between the first electrode and the second electrode, and in each battery cell the first electrode has a surface area larger than a surface area of the second electrode with the first electrode overhanging the second electrode in the stack.

18. The electrified vehicle of claim 17 wherein:
in each battery cell the solid electrolyte has a surface area that is the same as the surface area of the first electrode with the solid electrolyte together with the first electrode overhang the second electrode in the stack.

19. The electrified vehicle of claim 17 wherein:
in each battery cell the first electrode is an anode, and the second electrode is a cathode.

20. The electrified vehicle of claim 17 wherein:
in each battery cell the first electrode is a cathode, and the second electrode is an anode.
